(19) United States
(12) Patent Application Publication
(10) Pub. No.: US 2025/0018279 A1
(43) Pub. Date: Jan. 16, 2025

(54) GAME INTERACTION METHOD AND APPARATUS, COMPUTER STORAGE MEDIUM, AND ELECTRONIC DEVICE

(71) Applicant: NETEASE (HANGZHOU) NETWORK CO., LTD., Hangzhou, Zhejiang (CN)

(72) Inventor: Junle HE, Hangzhou, Zhejiang (CN)

(73) Assignee: NETEASE (HANGZHOU) NETWORK CO., LTD., Hangzhou, Zhejiang (CN)

(21) Appl. No.: 18/712,734

(22) PCT Filed: Jun. 27, 2022
(86) PCT No.: PCT/CN2022/101632

§ 371 Date: May 23, 2024

(30) Foreign Application Priority Data
Feb. 14, 2022 (CN) 202210135400.8

(51) Int. Cl. A63F 13/2145; A63F 13/533; A63F 13/87

(52) U.S. Cl. CPC A63F 13/2145; A63F 13/533; A63F 13/87

(57) ABSTRACT

A game interaction method, a game interaction apparatus, a computer storage medium, and an electronic device are disclosed. The game interaction method includes: displaying a game interface corresponding to a current player by means of a terminal device, and in response to touch operations on a first player character identifier and a second player character identifier, displaying at least one interaction control, where different interaction controls are configured for triggering the display of different game event information, and a first player and a second player are player characters participating in a current game; and in response to a touch operation on a target interaction control, determining, according to the target interaction control, game event information corresponding to the first player and the second player.

### CROSS REFERENCE TO RELATED APPLICATIONS

The present disclosure is a U.S. National Stage of International Application No. PCT/CN2022/101632, filed on Jun. 27, 2022, which claims the benefit of priority to a patent application filed with the CNIPA on Feb. 14, 2022, with application No. 202210135400.8 and titled “Game interaction method and apparatus, computer storage medium, and electronic device”, both of which are incorporated by reference herein in their entireties for all purposes.

### TECHNICAL FIELD

The present disclosure relates to the field of game technology, and in particular to a game interaction method, a game interaction device, a computer storage medium and an electronic device.

### BACKGROUND

With the continuous development of e-sports and mobile terminals, more and more competitive games can be installed on mobile terminals. During the game combat process, as the game battlefield changes, multiple players need to communicate with each other about strategy and tactics.

It should be noted that the information disclosed in the above background section is only used to enhance understanding of the background of the present disclosure.

### SUMMARY

Other features of the present disclosure will become apparent through the following detailed description, or will be partially acquired through the practice of the present disclosure.

According to a first aspect of the present disclosure, there is provided a game interaction method, including: displaying a game interface corresponding to a current player through a terminal device: displaying at least one interactive control in response to a touch operation on a first player character identification and a second player character identification, where different interactive controls are configured to trigger presentation of different game event information, and the first player and the second player are player characters participating in a current game; and determining, in response to a touch operation on a target interactive control, game event information corresponding to the first player and the second player based on the target interactive control: where, the game event information includes at least one of the following: economic information of the first player and the second player, and game strategies related to the first player and the second player.

According to a second aspect of the present disclosure, there is provided a non-transitory computer storage medium on which a computer program is stored, where when the computer program is executed by a processor, the game interaction method according to the above first aspect is implemented.

According to a third aspect of the present disclosure, there is provided an electronic device, including: a processor; and a memory for storing executable instructions for the processor: where, the processor is configured to execute the game interaction method according to the above first aspect by executing the executable instructions.

It should be understood that the present disclosure should be understood that the above general description and the later detailed description are only exemplary and explanatory and do not limit the present disclosure.

### BRIEF DESCRIPTION OF THE DRAWINGS

The accompanying drawings, which are incorporated in and constitute a part of this specification, illustrate embodiments consistent with the disclosure and together with the description, serve to explain the principles of the disclosure. Obviously, the drawings in the following description are only some embodiments of the present disclosure. For those of ordinary skill in the art, other drawings can be obtained based on these drawings without exerting creative efforts.

FIG. 1 shows a schematic flowchart of a game interaction method in an embodiment of the present disclosure:

FIG. 2 shows an operational schematic diagram of a game interaction method in an embodiment of the present disclosure:

FIG. 3 shows an operational schematic diagram of a game interaction method in another embodiment of the present disclosure:

FIG. 4 shows an operational schematic diagram of a game interaction method in yet another embodiment of the present disclosure:

FIG. 5 shows an operational schematic diagram of a game interaction method in yet another embodiment of the present disclosure:

FIG. 6 shows a schematic diagram of an interface for displaying game event information in an embodiment of the present disclosure:

FIG. 7 shows a schematic diagram of an interface for displaying game event information in another embodiment of the present disclosure:

FIG. 8 shows a schematic structural diagram of a game interaction device in an embodiment of the present disclosure:

FIG. 9 shows a schematic structural diagram of an electronic device in an embodiment of the present disclosure.

### DETAILED DESCRIPTION

Examples of the present disclosure will now be described more fully with reference to the accompanying drawings. Examples of the present disclosure may, however, be embodied in various forms and should not be construed as limited to the examples set forth herein: rather, these embodiments are provided so that the present disclosure will be thorough and complete, and will fully convey the concepts of the example embodiments to those skilled in the art. The described features, structures or characteristics may be combined in any suitable manner in one or more embodiments. In the following description, numerous specific details are provided to give a thorough understanding of embodiments of the disclosure. However, those skilled in the art will appreciate that the technical solutions of the present disclosure may be practiced without one or more of the specific details described, or other methods, components, devices, steps, etc. may be adopted. In other instances, well-known technical solutions have not been shown or described in detail to avoid obscuring aspects of the disclosure.

The terms “a”, “an”, “the” and “said” are used in this specification to indicate the existence of one or more elements/components/etc.: the terms “include” and “have” are used to indicate an open-ended inclusiveness and means that there may be additional elements/components/etc. in addition to those listed: the terms “first” and “second” etc. are used as labels only and do not refer to a limit on the number of its objects. Furthermore, the drawings are merely schematic illustrations of the present disclosure and are not necessarily drawn to scale. The same reference numerals in the drawings represent the same or similar parts, and thus their repeated description will be omitted. Some of the block diagrams shown in the figures are functional entities and do not necessarily correspond to physically or logically separate entities.

Currently, in MOBA (Multiplayer Online Battle Arena Games) games, tactical communication is generally carried out in the form of text or voice. Particularly:

The methods to send economic difference of a player include: \textcircled{1} players reminding teammates through text input and voice: \textcircled{2} clicking on economic data of a player in the battle information panel to send it to the target player. However, the above methods have the following drawbacks: \textcircled{1} it is difficult to take time to enter text in a fast-paced game, and players need to calculate the difference data between the two by themselves, and the accuracy of the calculation results is difficult to guarantee, which wastes time and effort of the player: \textcircled{2} only economic information for a single player can be sent: when the economic information of two players is sent continuously, there will be a cd (Call Duration) delay between the messages.

The methods to send one-to-one instructions include: \textcircled{1} reminding a teammate through text input and voice: \textcircled{2} sending team battle information. However, the above methods have the following drawbacks: \textcircled{1} it is difficult to take time to enter text in a fast-paced game: \textcircled{2} customized tactical deployment cannot be performed for a single character.

In the embodiments of the present disclosure, a game interaction method is first provided, which overcomes, at least to a certain extent, the draw backs in the related art of being unable to conveniently publish information that is clearly directed.

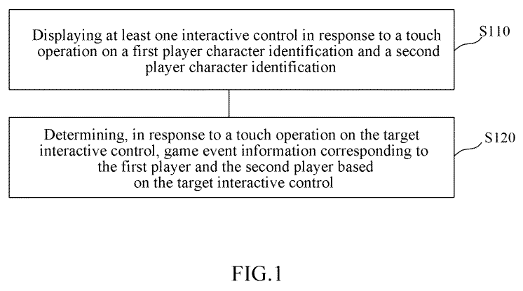

FIG. 1 shows a schematic flowchart of a game interaction method in an embodiment of the present disclosure. The execution subject of the game interaction method may be a server that processes the game interaction process.

Referring to FIG. 1, a game interaction method according to an embodiment of the present disclosure includes the following steps:

Step S110, displaying, in response to a touch operation on a first player character identification and a second player character identification, at least one interactive control: where different interactive controls are configured to trigger display of different game event information:

Step S120, determining, in response to a touch operation on a target interactive control, game event information corresponding to the first player and the second player based on the target interactive control: where the game event information includes at least one of the following: the economic information of the first player and the second player, and the game strategy related to the first player and the second player.

In the technical solution provided by the embodiment shown in FIG. 1, in response to the touch operation on the first player character identification and the second player character identification, at least one interactive control is displayed (different interactive controls are configured to trigger different game event information): in response to the touch operation on the target interactive control, the game event information corresponding to the first player and the second player (the economic information of the first player and the second player, and the game strategy related to the first player and the second player) are determined based on the target interactive control. Therefore, on the one hand, the present disclosure provides a convenient interactive method for publishing information that is clearly directed (i.e., information clearly related to two players), making up for the lack of interaction in related game products. On the other hand, it can achieve rapid information distribution and avoid the problems of information error and slowing down of game rhythm caused by text input.

The specific implementation process of each step in FIG. 1 is described in detail below:

The game interaction method in an embodiment of the present disclosure can be run on a local terminal device or a server. When the game interaction method runs on the server, the game interaction method can be implemented and executed based on a cloud interaction system, where the cloud interaction system includes a server and a client device.

In an optional implementation, various cloud applications, such as a cloud gam, can be run under the cloud interactive system. Take a cloud game as an example. The cloud game refers to a gaming method based on cloud computing. In the running mode of the cloud game, the running body of the game program and the presenting body of the game interface are separated. The storage and running of the game interaction method are completed on the cloud game server. The client device is configured to receive and send data as well as the presentation of the game interface. For example, the client device can be a display device with data transmission function close to the user side, such as a mobile terminal, a television, a computer, a handheld computer, a smart speaker, a smart watch, a smart vehicle, etc. But it is the cloud game server in the cloud that displays the game controls. When playing a game, the player operates the client device to send operating instructions to the cloud game server. The cloud game server runs the game according to the operating instructions, encodes and compresses the data such as the game interface, and returns it to the client device through the network. Finally, the client device decodes and outputs the game interface.

In an optional implementation, taking a game as an example, the local terminal device stores the game program and is configured to present the game interface. The local terminal device is configured to interact with players through a graphical user interface. That is, the game program is downloaded, installed and run conventionally through the electronic device. The local terminal device may provide the graphical user interface to the player in a variety of ways. For example, the graphical user interface may be rendered and displayed on the display screen of the terminal, or provided to the player through holographic projection. For example, the local terminal device may include a display screen and a processor. The display screen is configured to present a graphical user interface. The graphical user interface includes a game interface. The processor is configured to run the game, generate the graphical user interface, and control the display of the graphical user interface on the display screen.

The game interface refers to the graphical user interface (GUI) when running the game. The GUI interface refers to the computer operation user interface displayed graphically. The graphical user interface includes windows, drop-down menus, dialog boxes, and corresponding control mechanism, which are standardized in various new applications. That is, the same operation is always completed in the same way. In the graphical user interface, what the user sees and operates are graphical objects, applying the techniques of computer graphics.

After displaying the game interface corresponding to the current player through the terminal device, the current player can match teammates and enter the combat interface. The terminal device may be the local terminal device mentioned above or the client device in the cloud interactive system mentioned above. After entering the combat interface, the player can click on the relevant controls to enter the battle information panel. The battle information panel is a page that displays the combat status of each player in the game in real time. For example, in the battle information panel, the game avatar, game nickname, number of kills, number of deaths, blood volume, economy (that is, the number of gold coins obtained by the individual in the game), etc. for each player can be displayed. This can be set according to the actual situation, and the present disclosure does not impose special limitation on this.

The player character identification in the present disclosure is configured to indicate the identity of the player, which can be the game avatar, game nickname, etc. of the player. This can be set according to the actual situation, and the present disclosure does not impose special limitations on this. In the following embodiment, the player character identification being a game image is taken as an example for explanation.

In step S110, in response to a touch operation on a first player character identification and a second player character identification, at least one interactive control is displayed.

In this step, after the player clicks on the battle information panel, he or she can perform a touch operation on the first player character identification and the second player character identification to trigger the display of at least one interactive control.

The interactive control can trigger different functions (for example, display different game event information) when interacting with the player. For example, the game event information may be the economic information between the first player and the second player, and the game strategy related to the first player and the second player.

The first player and the second player are both player characters participating in the current game. Specifically, the first player can be a teammate of the current player, and the second player can be a teammate or opponent of the current player.

It should be noted that when the second player and the current player satisfy different relationships, interactive controls with different functions can be displayed. For example, when the second player is the opponent of the current player, the at least one interactive control may be an economic control (a control related to the economic information of the player), a duel control, and an evasion control (a functional control related to the game strategy). When the second player is a teammate of the current player, the at least one interactive control may be an economic control (a control related to the economic information of the player), a protection control, and a stay away control (a functional control related to the game strategy). The specific type, style and function of the control can be set according to the actual situation, which falls within the protection scope of the present disclosure.

For example, the above-mentioned at least one interactive control can be displayed within a preset distance range near the first player character identification, and covered (or semi-transparently displayed) above the nickname, blood volume and other related information of the first player. Or, the above-mentioned at least one interactive control can be displayed within a preset distance range near the second player character identification, and covered (or semi-transparently displayed) above the nickname, blood volume and other related information of the second player. The specific display position can be set according to the actual situation, and the present disclosure does not impose special limitations on this.

The function corresponding to the economic control may be: triggering calculation of the economic difference between the first player and the second player, and displaying the economic difference information. Therefore, the present disclosure can accurately calculate the economic difference between two players, reduce time and effort cost and calculation error of mental arithmetic, and save time and effort required for players to type or input through semantics.

The corresponding function of the duel control may be: generating and displaying prompt information for the first player to challenge the second player to a single combat. The function corresponding to the evasion control may be: generating and displaying prompt information for the first player to evade the second player. The corresponding function of the protection control may be: generating and displaying prompt information for the first player to protect the second player. The function corresponding to the stay away control may be: generating and displaying prompt information for the first player to stay away from the second player. Therefore, the present disclosure can issue combat operation suggestions (such as “pursue”, “stay away”, “protect”, etc.) between two players through a simple interactive method, achieve accurate distribution of strategic information which is clearly directed, and reduce delays and errors caused by text input.

In an optional implementation, the above-mentioned touch operation on the first player character identification and the second player character identification may include: an operation of dragging the first player identification to within the triggering range of the second player identification, or an operation of dragging the second player identification to within the triggering range of the first player identification. In the following embodiment, the drag operation being an operation of dragging the first player identification to within the triggering range of the second player identification is taken as an example for description.

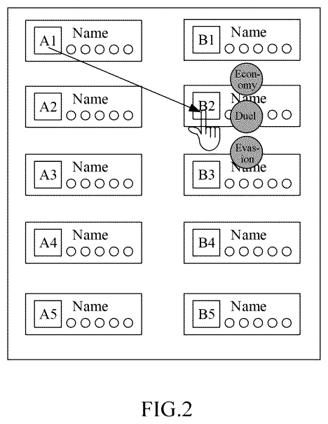

Taking the first player being the teammate of the current player and the second player being the opponent of the current player as an example, the specific operation process of the above drag operation will be described. Specifically, refer to FIG. 2, which shows an operational schematic diagram of a game interaction method in an embodiment of the present disclosure.

In FIGS. 2, A1 to A5 on the left represent the teammates of the current player, and B1 to B5 on the right represent the opponents of the current player. Therefore, if the current player drags the avatar of teammate A1 to the avatar of opponent B2, then at least one interactive control (economic control, duel control, evasion control) is triggered to display.

The corresponding function of the above-mentioned economic control may be: triggering the calculation of the economic difference between teammate A1 and opponent B2, and displaying the economic difference information. The function corresponding to the above-mentioned dual control may be: generating and displaying prompt information for A1 to challenge B2 to a single combat. The function corresponding to the above-mentioned evasion control may be: generating and displaying prompt information for teammate A1 to evade opponent B2.

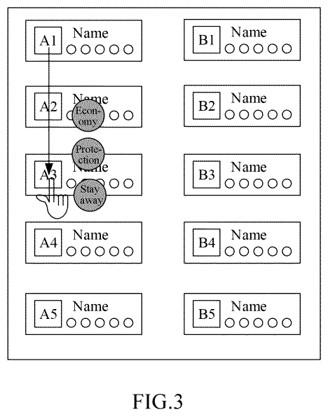

Taking the first player being a teammate of the current player and the second player being a teammate of the current player as an example, the specific operation process of the above drag operation will be described. Specifically, refer to FIG. 3, which shows an operational schematic diagram of a game interaction method in another embodiment of the present disclosure.

As shown in FIGS. 3, A1 to A5 on the left represent the teammates of the current player. Therefore, if the current player drags the avatar of teammate A1 to the avatar of teammate A3, at least one interactive control (economic control, protect control, stay away from control) is triggered to display:

The corresponding function of the above-mentioned economic control may be: triggering the calculation of the economic difference between teammate A1 and teammate A3, and displaying the economic difference information. The function corresponding to the above-mentioned protection control may be: generating and displaying prompt information for A1 to protect A3, and displaying the information. The function corresponding to the above-mentioned stay away control may be: generating and displaying prompt information for A1 to stay away from A3, and displaying the information.

In another optional implementation, the above-mentioned touch operation on the first player character identification and the second player character identification may be a long press operation, and the long press operation is a first long press operation on the first player character identification, and a second long press operation on the second player character identification.

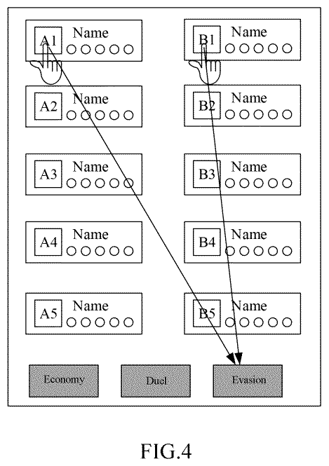

Taking the first player being the teammate of the current player and the second player being the opponent of the current player as an example, the specific operation process of the above long press operation will be described. Specifically, refer to FIG. 4, which shows an operational schematic diagram of a game interaction method in yet another embodiment of the present disclosure.

As shown in FIG. 4, if the current player performs the first long press operation on the avatar of teammate A1, and performs the second long press operation on the avatar of opponent B2 within the subsequent preset time period (for example: 1 second, which can be set or changed according to the actual situation), the above-mentioned at least one interactive control (economic control, duel control, and evasion control) can be triggered to display:

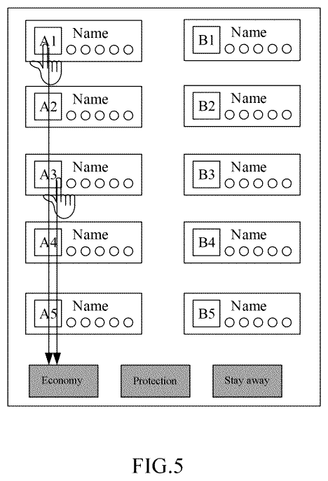

Taking the first player being the teammate of the current player and the second player being the teammate of the current player as an example, the specific operation process of the above long press operation will be described. Specifically, refer to FIG. 5, which shows an operational schematic diagram of a game interaction method in yet another embodiment of the present disclosure.

As shown in FIG. 5, if the current player performs the first long press operation on the avatar of teammate A1, and performs the second long press operation on the avatar of teammate A3 within the subsequent preset time period, the above-mentioned at least one of the interactive controls (economic control, protection control, stay away control) can be triggered to display:

Continuing to refer to FIG. 1, in step S120, in response to a touch operation on the target interactive control, game event information corresponding to the first player and the second player is determined based on the target interactive control.

In this step, after displaying the above-mentioned at least one of the interactive controls, the operations of the current player can be monitored. If it is detected that the player does not perform a touch operation on any of the interactive controls within a preset time period (for example: 2 seconds, which can be set or changed according to the actual situation) at least one of the above interactive controls can be hidden to avoid the interface being occupied for a long time and affecting the user operation.

If it is detected that the current player performs a touch operation on any target interactive control within a preset time period, the game event information corresponding to the first player and the second player can be determined based on the target interactive control.

In an optional implementation, the touch operation on the target interactive control may be a click operation.

Take the current player dragging the avatar of teammate A1 to the avatar of opponent B2 as an example. After at least one interactive control is displayed, the current player can click on any of the target interactive controls (for example, click, double-click etc.). Furthermore, the game event information corresponding to the first player and the second player can be determined based on the target interactive control clicked by the current player.

For example, if the current player clicks on the economic control, then the economic information of teammate A1 (for example: 3234, depending on the actual situation), the economic information of opponent B2 (for example: 2000, depending on the actual situation) can be obtained, and the difference between the two is calculated (3234−2000=1234), and then the game event information is determined as “the economy of A1 is 1234 points higher than the economy of B2”. If the current player clicks the duel control, then the game event information can be determined as “A1 challenge B2 to a single combat”. If the current player clicks on the evasion control, the game event information can be determined as “teammate A1 evade the pursuit of opponent B2.”

Take the current player dragging the avatar of teammate A1 to the avatar of teammate A3 as an example. After at least one interactive control is displayed, the current player can click on any of the target interactive controls (for example, click, double-click etc.) to trigger the game event information corresponding to the target interactive control.

For example, if the current player clicks on the economic control, then the economic information of teammate A1 (for example: 3234, depending on the actual situation), the economic information of teammate A3 (for example: 2000, depending on the actual situation) can be obtained, and the difference between the two is calculated (3234−2000=1234), and then the game event information is determined as “the economy of A1 is 1234 points higher than the economy of A3”. If the current player clicks on the protection control, the game event information can be determined as “A1 protects A3”. If the current player clicks the stay away control, the game event information can be determined as “A1 stays away from A3”.

In another optional implementation, the touch operation on the target interactive control may be dragging the first player character identification to the target interactive control after performing the first long press operation on the first player character identification, and dragging the second player character identification to the target interactive control after performing the second long press operation on the second player character identification, and performing a release operation on the first player identification and the second player identification.

The current player performing the first long press operation on the avatar of teammate A1 and performing the second long press operation on the avatar of opponent B2 is taken as an example for description. After at least one interactive control is displayed, the current player can drag the avatar of teammate A1 and the avatar of opponent B2 to the target interactive control and release them to trigger game event information corresponding to the target interactive control without the touch medium (finger, or other touch medium, such as a stylus, etc., which can be set according to the actual situation) leaving the touch screen.

For example, if the current player drags the avatars of teammate A1 and opponent B2 to the economic control and releases them, the game event information is determined as “the economy of A1 is 1234 points higher than the economy of B2”. If the current player drags the avatars of teammate A1 and opponent B2 to the duel control and releases them, the game event information can be determined as “A1 challenge B2 to a single combat”. Next, referring to FIG. 4, if the current player drags the avatars of teammate A1 and opponent B2 to the evasion control and releases them, the game event information can be determined as “teammate A1 evade the pursuit of opponent B2.”

The current player performing the first long press operation on the avatar of teammate A1 and performing the second long press operation on the avatar of teammate A3 is taken as an example for description. After at least one interactive control is displayed, the current player can drag the avatar of teammate A1 and the avatar of teammate A3 to the target interactive control and release them to trigger the game event information corresponding to the target interactive control without the touch medium leaving the touch screen.

For example, referring to FIG. 5, if the current player drags the avatars of teammate A1 and teammate A3 to the economic control and releases them, the game event information can be determined as “the economy of A1 is 1234 points higher than the economy of A3”. If the current player drags the avatars of teammate A1 and teammate A3 to the protection control and releases them, the game event information can be determined as “A1 protects A3”. If the current player drags the avatars of teammate A1 and teammate A3 to the stay away control and releases them, the game event information can be determined as “A1 stays away from A3”.

It should be noted that if the current player drags the identifications of the first player and the second player to different interactive controls, for example: if the current player drags the avatar of teammate A1 to the economic control, and drags the avatar of teammate A3 to the protection control, then in an optional implementation, it can be determined that the operation is a misoperation of the user and the above interactive control can be hidden. In another optional implementation, two game event information can be generated at the same time. For example, the economy of A1 is 1234 points higher than the economy of A3, and A1 protects A3, which can be set according to the actual situation, and falls within the scope of protection of the present disclosure.

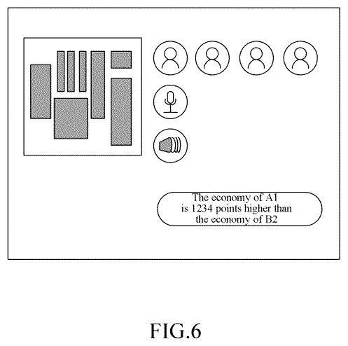

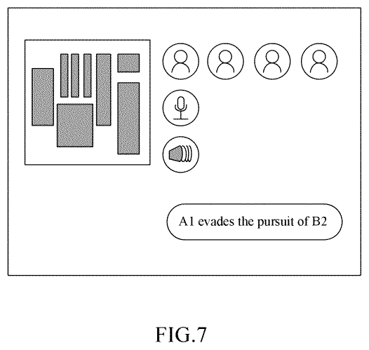

After the above game event information is determined, in an optional implementation, the above game event information can be displayed in the game chat interface so that teammates in the same team can see it. For example, a game map can be displayed in the upper left corner of the game chat interface, and an icon of each player in the combat team, a microphone logo for voice chat, and a speaker logo for adjusting the volume can be displayed on the right side of the game map. Referring to FIG. 6, FIG. 6 shows a schematic diagram of an interface for displaying game event information in an embodiment of the present disclosure, specifically shows a schematic diagram of the interface when “the economy of A1 is 1234 points higher than the economy of B2”. Referring to FIG. 7, FIG. 7 shows a schematic diagram of an interface for displaying game event information in another embodiment of the present disclosure, specifically shows a schematic diagram of the interface when “A1 evades the pursuit of B2”.

After the above game event information is determined, in another optional implementation, the above game event information may be sent to the first player and/or the second player.

Specifically, when the game event information is the economic information of the first player and the second player, the recipient of the game event information can be determined based on the relationship between the second player and the current player and the specific situation of the game event information. For example, when the first player is a teammate of the current player, the second player is the opponent of the current player, and the game event information is “the economy of the first player is 1234 points higher than the economy of the second player”, the above game event information can be sent to the second player to achieve the effect of provoking the opponent. If the game event information is “the economy of the first player is 1234 points lower than the economy of the second player”, then the above game event information can be sent to the first player, to achieve the effect of prompting and motivating teammates. When the first player is a teammate of the current player and the second player is also a teammate of the current player, the above game event information can be sent to the first player and the second player at the same time.

Optionally, in the method provided by the present disclosure, the current player can also send the game event information to a certain player through text or voice or to the game chat interface, which can be chosen according to the needs of the current player. The present disclosure does not impose special limitations on this.

In particular, when the game event information is the economic information of the first player and the second player, the current player can also click on the economic information displayed on the battle information panel to send the economic information of the first player and the second player to a certain player or the game chat interface. Specifically, taking the game event information being the economic information of teammate A1 and opponent B2 as an example, the current player can first click on the economy of teammate A1 in the battle information panel to send it to a selected player or send it to the game chat interface, and then click the economy of opponent B2 in the battle information panel to send it to the selected player above or send it to the game chat interface.

It should be noted that when displaying the above game event information, the above game event information can be set to be played in the form of voice to reduce the burden on the field of vision of the player and ensure that the corresponding player quickly pays attention to the information and adopts corresponding game strategies.

Based on the above technical solution, on the one hand, the present disclosure can save the time and effort required for players to type or speak, and can also accurately calculate the economic difference between two players, thereby reducing the time cost and error of the mental arithmetic of the player. On the other hand, the present disclosure can realize the distribution of individual-to-individual combat operation suggestions (such as “pursuit”, “stay away”, “protect”) in a simple interactive manner, making up for the shortcomings of the lack of this type of interaction means in related art. The present disclosure achieves accurate distribution of operational strategic information and avoid information errors and time consumption caused by text input.

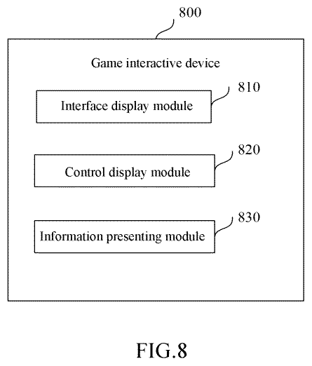

The present disclosure also provides a game interaction device. FIG. 8 shows a schematic structural diagram of the game interaction device in an embodiment of the present disclosure. As shown in FIG. 8, the game interaction device 800 may include an interface display module 810 and a control display module 820 and an information presenting module 830.

The interface display module 810 is configured to display the game interface corresponding to the current player.

The control display module 820 is configured to display at least one interactive control in response to a touch operation on a first player character identification and a second player character identification. Different interactive controls are configured to trigger the display of different game event information. The first player and the second player are the player characters participating in the current game.

The information presenting module 830 is configured to determine, in response to the touch operation on the target interactive control, the game event information corresponding to the first player and the second player based on the target interactive control. The game event information includes at least one of the following: economic information of the first player and the second player, and game strategies related to the first player and the second player.

In an exemplary embodiment of the present disclosure, the first player includes a teammate of the current player; and the second player includes a teammate or an opponent of the current player.

In an exemplary embodiment of the present disclosure, the touch operation on the first player character identification and the second player character identification includes: a drag operation for moving the first player character identification to within the trigger range of the second player character identification: or, a drag operation for dragging the second player character identification to within the trigger range of the first player character identification: a long press operation, the long press operation is a first long press operation on the first player character identification, and a second long press operation on the second player character identification.

In an embodiment of the present disclosure, when the touch operation is the drag operation, the touch operation on the target interactive control includes: a click operation on the target interactive control.

In an embodiment of the present disclosure, when the touch operation is the long press operation, the touch operation on the target interactive control includes: dragging the first player character identification to the target interactive control after the first long press operation, and dragging the second player identification to the target interactive control after the second long press operation; and releasing the first player identification and the second player identification.

In an embodiment of the present disclosure, after determining the game event information corresponding to the first player and the second player, the information presenting module 830 is configured to:
present the game event information to the first player and/or the second player: or present the game event information in a game chat interface.

In an embodiment of the present disclosure, after determining the game event information corresponding to the first player and the second player, the information presenting module 830 is configured to play the game event information in voice form.

The specific details of each module in the above game interaction device have been described in detail in the corresponding game interaction method, so they will not be repeated here.

It should be noted that although several modules or units of device for action execution are mentioned in the above detailed description, this division is not mandatory. In fact, according to embodiments of the present disclosure, the features and functions of two or more modules or units described above may be embodied in one module or unit. Conversely, the features and functions of one module or unit described above may be further divided into being embodied by multiple modules or units.

Furthermore, although various steps of the methods of the present disclosure are depicted in the drawings in a specific order, this does not require or imply that the steps must be performed in that specific order, or that all of the illustrated steps must be performed to achieve the desired results. Additionally, or alternatively, certain steps may be omitted, multiple steps may be combined into one step for execution, and/or one step may be decomposed into multiple steps for execution, etc.

Through the above description of the embodiments, those skilled in the art can easily understand that the example embodiments described here can be implemented by software, or can be implemented by software combined with necessary hardware. Therefore, the technical solution according to the embodiment of the present disclosure can be embodied in the form of a software product, which can be stored in a non-volatile storage medium (which can be a CD-ROM, U disk, mobile hard disk, etc.) or on the network, and include several instructions to cause a computing device (which may be a personal computer, a server, a mobile terminal, a network device, etc.) to execute a method according to an embodiment of the present disclosure.

The present disclosure also provides a computer-readable storage medium. The computer-readable storage medium may be included in the electronic device described in the above embodiments: it may also exist independently without being assembled into the electronic device.

The computer-readable storage medium may be, for example, but is not limited to, an electrical, magnetic, optical, electromagnetic, infrared, or semiconductor system, apparatus or device, or any combination thereof. More specific examples of computer readable storage media may include, but are not limited to: an electrical connection having one or more wires, a portable computer disk, a hard drive, random access memory (RAM), read only memory (ROM), erasable programmable read-only memory (EPROM or flash memory), optical fiber, portable compact disk read-only memory (CD-ROM), optical storage device, magnetic storage device, or any suitable combination of the above. In the present disclosure, a computer-readable storage medium may be any tangible medium that contains or stores a program for use by or in connection with an instruction execution system, apparatus, or device.

The computer-readable storage media may transmit, propagate, or transport a program for use by or in connection with an instruction execution system, apparatus, or device. Program code embodied on a computer-readable storage medium may be transmitted using any suitable medium, including but not limited to: wireless, wire, optical cable, RF, etc., or any suitable combination of the above.

The computer-readable storage medium carries one or more programs. When the one or more programs are executed by an electronic device, the electronic device implements the method described in the above embodiments to achieve the effect of convenient sending information that is clearly directed in a game. Specifically, the following steps can be achieved.

The game interface corresponding to the current player is displayed through the terminal device. At least one interactive control is displayed in response to the touch operation on the first player character identification and the second player character identification. Different interactive controls are configured to trigger the presentation different game event information. The first player and the second player are player characters participating in the current game. In response to the touch operation on the target interactive control, the game event information corresponding to the first player and the second player is determined according to the target interactive control. The game event information includes at least one of the following: economic information of the first player and the second player, and game strategies related to the first player and the second player.

Optionally, the first player includes a teammate of the current player; and the second player includes a teammate or an opponent of the current player.

Optionally, the touch operation on the first player character identification and the second player character identification includes: a drag operation for dragging the first player character identification to within the triggering range of the second player character identification: or, a drag operation for dragging the second player character identification to within the triggering range of the first player character identification: a long Press operation, the long press operation is a first long press operation on the first player character identification, and a second long press operation on the second player character identification.

Optionally, when the touch operation is the drag operation, the touch operation on the target interactive control includes: a click operation on the target interactive control.

Optionally, when the touch operation is the long press operation, the touch operation on the target interactive control includes: dragging the first player character identification to the target interactive control after the first long press operation, and dragging the second player character identification to the target interactive control after the second long press operation; and releasing the first player identification and the second player identification.

Optionally, after determining the game event information corresponding to the first player and the second player, it further includes: presenting the game event information to the first player and/or the second player: or, presenting the game event information in the game chat interface.

Optionally, after determining the game event information corresponding to the first player and the second player, it further includes: playing the game event information in the form of voice.

Based on the above technical solution, on the one hand, the present disclosure provides a convenient interactive method for issuing information that is clearly directed (that is, information clearly related to two players), which makes up for the lack of interaction in related game products. On the other hand, it can achieve rapid information distribution and avoid the problems of information errors and slowing down the pace of the game caused by text input.

In addition, an electronic device capable of implementing the above method is also provided in an embodiment of the present disclosure.

Those skilled in the art will understand that various aspects of the present disclosure may be implemented as systems, methods, or program products. Therefore, various aspects of the present disclosure may be embodied in the following forms, namely: a complete hardware implementation, a complete software implementation (including firmware, microcode, etc.), or an implementation combining hardware and software aspects, which may be collectively referred to herein as “Circuit”, “Module” or “System”.

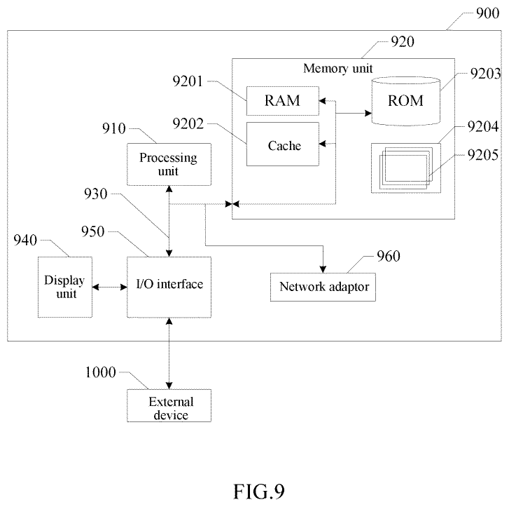

An electronic device 900 according to this embodiment of the present disclosure is described below with reference to FIG. 9. The electronic device 900 shown in FIG. 9 is only an example and should not impose any limitations on the functions and scope of use of the embodiments of the present disclosure.

As shown in FIG. 9, the electronic device 900 is embodied in the form of a general computing device. The components of the electronic device 900 may include, but are not limited to: the above-mentioned at least one processing unit 910, the above-mentioned at least one storage unit 920, a bus 930 connecting different system components (including the storage unit 920 and the processing unit 910), and the display unit 940.

The storage unit stores program code, and the program code can be executed by the processing unit 910, so that the processing unit 910 performs various exemplary methods according to the present disclosure described in the “Example Method” section of this specification. The steps of the implementation method are implemented to achieve the effect of conveniently sending information that is clearly directed in the game. Specifically, the following steps can be implemented:

The game interface corresponding to the current player is displayed through the terminal device, and at least one interactive control is displayed in response to the touch operation on the first player character identification and the second player character identification. Different interactive controls are configured to trigger the presentation of different game event information. The first player and the second player are player characters participating in the current game. In response to the touch operation on the target interactive control, the game event information corresponding to the first player and the second player is determined based on the target interactive control. The game event information includes at least one of the following: economic information of the first player and the second player, and game strategies related to the first player and the second player.

Optionally, the first player includes a teammate of the current player; and the second player includes a teammate or an opponent of the current player.

Optionally, the touch operation on the first player character identification and the second player character identification includes: a drag operation for dragging the first player character identification to within the triggering range of the second player character identification: or, a drag operation for dragging the second player character identification to within the triggering range of the first player character identification; and a long press operation, the long press operation is a first long press operation on the first player character identification, and a second long press operation on the second player character identification.

Optionally, when the touch operation is the drag operation, the touch operation on the target interactive control includes: a click operation on the target interactive control.

Optionally, when the touch operation is the long press operation, the touch operation on the target interactive control includes: dragging the first player character identification to the target interactive control after the first long press operation, and dragging the second player character identification to the target interactive control after the second long press operation; and releasing the first player identification and the second player identification.

Optionally, after determining the game event information corresponding to the first player and the second player, it further includes: presenting the game event information to the first player and/or the second player: or, presenting the game event information in the game chat interface.

Optionally, after determining the game event information corresponding to the first player and the second player, the method further includes: playing the game event information in the form of voice.

Based on the above technical solution, on the one hand, the present disclosure provides a convenient interactive method for issuing information that is clearly directed (that is, information clearly related to two players), which makes up for the lack of interaction in related game products. On the other hand, it can achieve rapid information distribution and avoid the problems of information errors and slowing down the pace of the game caused by text input.

The storage unit 920 may include a readable medium in the form of a volatile storage unit, such as a random access storage unit (RAM) 9201 and/or a cache storage unit 9202, and may further include a read-only storage unit (ROM) 9203.

The storage unit 920 may also include a program/utility 9204 having a set of (at least one) program modules 9205 including, but not limited to: an operating system, one or more application programs, other program modules, and program data. Each of these examples, or some combination, may include the implementation of a network environment.

The bus 930 may represent one or more of several types of bus structures, including a memory unit bus or memory unit controller, a peripheral bus, a graphics acceleration port, a processing unit, or local area bus using any of a variety of bus structures.

The electronic device 900 may also communicate with one or more external devices 1000 (e.g., keyboard, pointing device, Bluetooth device, etc.), may also communicate with one or more devices that enable a user to interact with electronic device 900, and/or with any device (e.g., router, modem, etc.) that enables the electronic device 900 to communicate with one or more other computing devices. This communication may occur through input/output (I/O) interface 950. Furthermore, the electronic device 900 may also communicate with one or more networks (e.g., a local area network (LAN), a wide area network (WAN), and/or a public network, such as the Internet) through the network adapter 960. As shown, the network adapter 960 communicates with other modules of electronic device 900 via bus 930. It should be understood that, although not shown in the figure, other hardware and/or software modules may be used in conjunction with electronic device 900, including but not limited to: microcode, device drivers, redundant processing units, external disk drive arrays, RAID systems, tape drives and data backup storage system, etc.

Other embodiments of the disclosure will be readily apparent to those skilled in the art from consideration of the specification and practice of the present disclosure herein. This application is intended to cover any variations, uses, or adaptations of the disclosure that follow the general principles of the disclosure and include common knowledge or customary technical means in the technical field that are not disclosed in the disclosure. It is intended that the specification and examples be considered as exemplary only, with a true scope and spirit of the disclosure being indicated by the following claims.

What is claimed:

1. A game interaction method performed by a terminal device, comprising:
displaying a game interface corresponding to a current player;
displaying at least one interactive control in response to detecting a first touch operation on at least one of a first player character identification or a second player character identification, wherein different interactive controls are configured to trigger presentation of different game event information, and a first player and a second player are player characters participating in a current game; and
determining, in response to detecting a second touch operation on a target interactive control, game event information corresponding to the first player and the second player based on the target interactive control;
wherein, the game event information comprises at least one of the following information: economic information of the first player and the second player, or game strategies related to the first player and the second player.

2. The method according to claim 1, wherein the first player comprises a teammate of the current player; and the second player comprises a teammate or an opponent of the current player.

3. The method according to claim 1, wherein the first touch operation on at least one of the first player character identification or the second player character identification comprises:
a drag operation, wherein the drag operation is an operation of dragging the first player character identification to within a triggering range of the second player character identification; or,
a drag operation, wherein the drag operation comprises an operation of dragging the second player character identification to within a triggering range of the first player character identification; and
a long press operation, wherein the long press operation is a first long press operation on the first player character identification, and a second long press operation on the second player character identification.

4. The method according to claim 3, wherein in response to determining that the first touch operation is the drag operation, the second touch operation on the target interactive control comprises:
a click operation on the target interactive control.

5. The method according to claim 3, wherein in response to determining that the touch first operation is the long press operation, the second touch operation on the target interactive control comprises:
dragging the first player character identification to the target interactive control after the first long press operation, and dragging the second player character identification to the target interactive control after the second long press operation; and
performing an operation of releasing the first player character identification and the second player character identification.

6. The method according to claim 1, further comprising:
presenting the game event information to at least one of the first player and/or the second player: or,
presenting the game event information in a game chat interface.

7. The method according to claim 6, further comprising:
playing the game event information in a form of voice.

8. (canceled)

9. A non-transitory computer storage medium on which a computer program is stored, wherein by executing the computer program, a processor is configured to:
display a game interface corresponding to a current player;
display at least one interactive control in response to detecting a first touch operation on at least one of a first player character identification or a second player character identification, wherein different interactive controls are configured to trigger presentation of different game event information, and a first player and a second player are player characters participating in a current game; and
determine, in response to detecting a second touch operation on a target interactive control, game event information corresponding to the first player and the second player based on the target interactive control;
wherein, the game event information comprises at least one of the following information: economic information of the first player and the second player, or game strategies related to the first player and the second player.

10. An electronic device, comprising:
a processor; and
a memory for storing executable instructions for the processor;
wherein, by executing the executable instructions, the processor is configured to:
display a game interface corresponding to a current player;
display at least one interactive control in response to detecting a first touch operation on at least one of a first player character identification or a second player character identification, wherein different interactive controls are configured to trigger presentation of different game event information, and a first player and a second player are player characters participating in a current game; and
determine, in response to detecting a second touch operation on a target interactive control, game event information corresponding to the first player and the second player based on the target interactive control;
wherein, the game event information comprises at least one of the following information: economic information of the first player and the second player, or game strategies related to the first player and the second player.

11. The device according to claim 10, wherein the first player comprises a teammate of the current player; and the second player comprises a teammate or an opponent of the current player.

12. The device according to claim 10, wherein the first touch operation on at least one of the first player character identification or the second player character identification comprises:
a drag operation, wherein the drag operation is an operation of dragging the first player character identification to within a triggering range of the second player character identification; or,
a drag operation, wherein the drag operation is an operation of dragging the second player character identification to within a triggering range of the first player character identification; and
a long press operation, wherein the long press operation comprises a first long press operation on the first player character identification, and a second long press operation on the second player character identification.

13. The device according to claim 12, wherein in response to determining that the first touch operation is the drag operation, the second touch operation on the target interactive control comprises:
a click operation on the target interactive control.

14. The device according to claim 12, wherein in response to determining that the first touch operation is the long press operation, the second touch operation on the target interactive control comprises:
dragging the first player character identification to the target interactive control after the first long press operation, and dragging the second player character identification to the target interactive control after the second long press operation; and
performing an operation of releasing the first player character identification and the second player character identification.

15. The device according to claim 10, wherein the processor is further configured to:
present the game event information to at least one of the first player or the second player: or,
present the game event information in a game chat interface.

16. The device according to claim 15, wherein the processor is further configured to:
play the game event information in a form of voice.

17. The non-transitory computer storage medium according to claim 9, wherein the first player comprises a teammate of the current player; and the second player comprises a teammate or an opponent of the current player.

18. The non-transitory computer storage medium according to claim 9, wherein the first touch operation on at least one of the first player character identification and the second player character identification comprises:
a drag operation, wherein the drag operation is an operation of dragging the first player character identification to within a triggering range of the second player character identification: or,
a drag operation, wherein the drag operation is an operation of dragging the second player character identification to within a triggering range of the first player character identification; and
a long press operation, wherein the long press operation comprises a first long press operation on the first player character identification, and a second long press operation on the second player character identification.

19. The non-transitory computer storage medium according to claim 18, wherein in response to determining that the first touch operation is the drag operation, the second touch operation on the target interactive control comprises:
a click operation on the target interactive control.

20. The non-transitory computer storage medium according to claim 18, wherein in response to determining that the first touch operation is the long press operation, the second touch operation on the target interactive control comprises:
dragging the first player character identification to the target interactive control after the first long press operation, and dragging the second player character identification to the target interactive control after the second long press operation; and
performing an operation of releasing the first player character identification and the second player character identification.

21. The non-transitory computer storage medium according to claim 9, wherein the processor is further configured to:
present the game event information to at least one of the first player or the second player: or,
present the game event information in a game chat interface.
